(19) United States
(12) Patent Application Publication
(10) Pub. No.: US 2014/0358713 A1
(43) Pub. Date: Dec. 4, 2014

(54) METHOD AND SYSTEM FOR BULK PURCHASE NEGOTIATING USING AN AD HOC ONLINE GROUP

(71) Applicants: Gyan Prakash, Beaverton, OR (US); Jesse Walker, Hillsboro, OR (US); David Stanasolovich, Albuquerque, NM (US); James R. Gregg, Phoenix, AZ (US); Rajesh Poornachandran, Portland, OR (US)

(72) Inventors: Gyan Prakash, Beaverton, OR (US); Jesse Walker, Hillsboro, OR (US); David Stanasolovich, Albuquerque, NM (US); James R. Gregg, Phoenix, AZ (US); Rajesh Poornachandran, Portland, OR (US)

(21) Appl. No.: 13/997,793

(22) PCT Filed: Dec. 30, 2011
(86) PCT No.: PCT/US2011/068127

§ 371 Date: Aug. 21, 2014

(51) Int. Cl. G06Q 30/08

(52) U.S. Cl. CPC G06Q 30/08
USPC 705/26.3

(57) ABSTRACT

A method and system enables the formation of an ad hoc group to negotiate a bulk purchase of a product or service in an online user networking environment and to execute the bulk purchase using an electronic commerce transaction.

### BACKGROUND

Telecommunications networks such as the Internet enable electronic communications among people and business entities for a variety of purposes. Online communities, such as bulletin boards, forums, chat rooms, and social networking sites, to name a few, can facilitate interaction among people using various forms of real-time electronic messaging technology (e.g., instant messaging, chat, and/or others). Many online communities including social networks, such as FACEBOOK, and asynchronous user networking applications, such as TWITTER, provide an environment in which a user's electronic communications can be viewed by a large number of people, depending on the preferences of the particular user. As a result, people who use these and similar services can find, “connect,” and interact online with people whom they know and/or people who are otherwise unknown to them, but who may share a common interest. Increasingly, businesses are using these platforms to identify and communicate with customers.

### BRIEF DESCRIPTION OF THE DRAWINGS

The invention described herein is illustrated by ay of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a system for conducting online bulk purchase negotiations;

FIG. 2 is a simplified module diagram for at least one embodiment of the system of FIG. 1;

FIG. 3 is a simplified data model diagram usable in connection with at least one embodiment of the system of FIG. 1;

FIG. 4 is a simplified flow diagram of at least one embodiment of a method of facilitating an online bulk purchase negotiation;

FIG. 5 is a simplified graphic of at least one embodiment of a display screen connection with the system of FIG. 1; and

FIG. 6 is a simplified graphic of at least one embodiment of another display screen usable in connection with the system of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the mention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions carried by or stored on a transitory or non-transitory machine-readable medium, which may be read and executed by one or more processors. A machine-readable medium may be embodied as any device, mechanism or physical structure for storing or transmitting information in a form readable by a machine (e.g., a computing device). For example, a machine-readable medium may be embodied as read only memory (ROM); random access memory (RAM); magnetic disk storage media; optical storage media; flash memory devices; mini- or micro-SD cards, memory sticks, electrical signals, and others.

In the drawings, specific arrangements or orderings of schematic elements such as those representing devices, modules, instruction blocks and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

In general, schematic elements used to represent instruction blocks may be implemented using any suitable form of machine-readable instruction, such as software or firmware applications, programs, functions, modules, routines, processes, procedures, plug-ins, applets, widgets, code fragments and/or others, and that each such instruction may be implemented using any suitable programming language, library, application programming interface (API), and/or other software development tools. For example, some embodiments may be implemented using Java, C++, and/or other programming languages.

Similarly, schematic elements used to represent data or information may be implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. Also, for ease of illustration, a single connecting element may be used to represent multiple connections, relationships or associations between elements. For example, where a connecting element represents a communication of signals data or instructions, it should be understood by those skilled in the art that such element may represent one or multiple signal paths (e.g., a bus) as may be needed, to effect the communication.

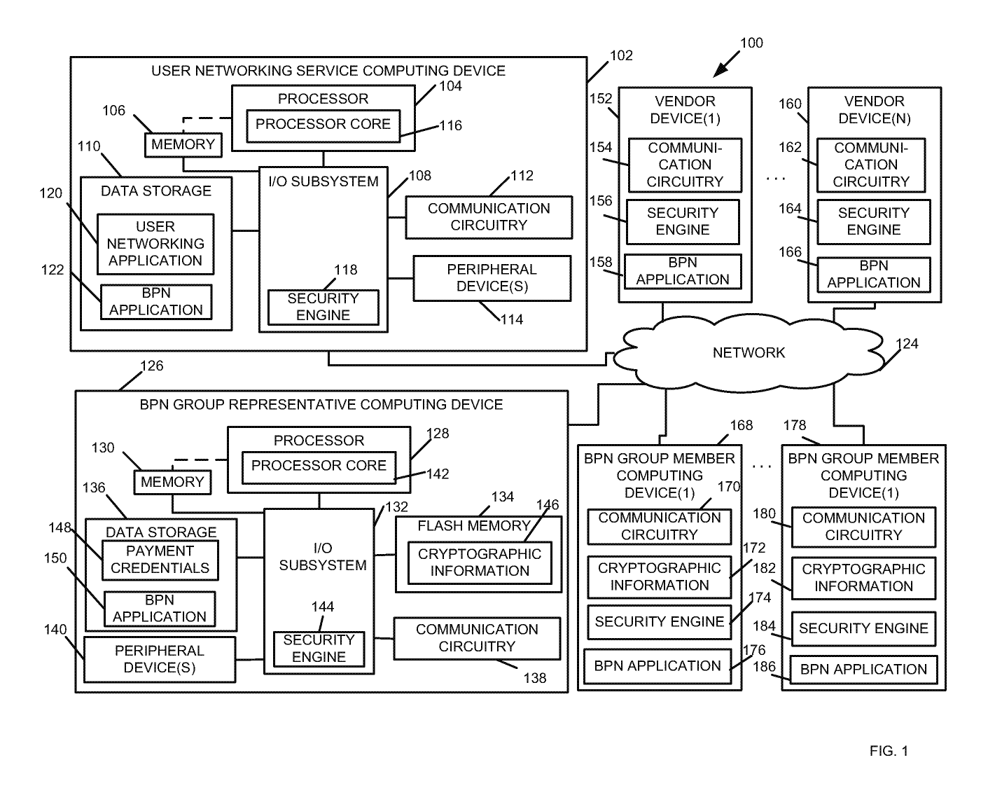

Referring now to FIG. 1, an illustrative system 100 for facilitating the formation of an ad hoc online group for negotiating a bulk purchase of a desired product, commodity and/or service, and facilitating bulk purchase negotiations and bulk purchases by the ad hoc online group is shown. The term “product, commodity and/or service” as used herein is intended to include both physical goods, which may require shipping and return policies, and “digital” products, commodities, and/or services. Some examples of digital products, commodities and/or services include electronic books (“e-books”), digital music files, computer storage (e.g., “cloud” storage), software downloads, online subscription services, digital movies, electronic tickets (e.g., conceit movie, show, sporting event plane, or train tickets), and electronic reservations (e.g., travel, dining, or other reservations), to name a few.

The term “ad hoc” is used to imply that at least in some embodiments; the online group may be formed solely for the purpose of conducting a particular bulk purchase negotiation and then disbanded. For example, in some embodiments, the ad hoc online group may be formed of individuals who have little or no prior relationship with one another yet have a common interest in purchasing a particular product, commodity and/or service within a particular time period, and a desire to negotiate a better deal for the purchase.

The system 100 includes a user networking service computing device 102. The user networking service computing device 102 can be communicatively coupled to a bulk purchase negotiation (BPN) group representative computing device 126; one or more BPN group member computing devices (1) to (n) 168, 178 (here n is a positive integer); and one or more vendor devices (1) to (n) 152, 160 (where n is a positive integer), via a network 124.

A user networking application 120 is embodied as computerized logic in or otherwise accessible to the user networking service computing device 102. The user networking application 120 enables the user networking service computing device 102 to support an online user networking environment, such as an online community (e.g., a social networking site and/or an asynchronous user networking application), in which users of the computing devices 126, 152, 160, 168, and/or 178 can interact with one another using real-time electronic communications (e.g., chat, instant messaging, and/or other suitable electronic communications technology).

As described in more detail below, the illustrative system 100 also includes a BPN application 122, 150, 158, 166, 176, 186. The BPN application 122, 150, 158, 166, 176, 186 is embodied as computerized logic executable from within the user networking application 120, for example. The BPN application 122, 150, 158, 166, 176, 186 is configured to enable the formation of an ad hoc group of users of the user networking application 120, manage the group's membership, facilitate the exchange of electronic messages among the group's members relating to a bulk purchase negotiation, facilitate the exchange of electronic messages between the group or a representative thereof and vendors involved in a bulk purchase negotiation, and initiate electronic commerce transactions for bulk purchases by or on behalf of the group. The illustrative BPN application 122, 150, 158, 166, 176, 186 includes a “back end” BPN application 122 and one or more “front end” graphical user interface applications 150, 158, 166, 176, 186. The back end application 122 resides at the user networking service computing device 102, while the front end applications 150, 158, 166, 176, 186 reside at, respectively, the BPN group representative computing device 126, the vendor devices 152, 160, and the BPN group member computing devices 168, 178.

The illustrative back end application 122 is embodied as computerized logic configured to process instructions and information relating to bulk purchase negotiations by ad hoc online groups, facilitate electronic communications between or among the various entities involved in the bulk purchase negotiations, and initiate electronic commerce transactions resulting from the bulk purchase negotiations. The illustrative front end applications 150, 158, 166, 176, 186 are embodied as computerized logic configured to operate a graphical user interface to input and display information relating to the bulk purchase negotiations at the devices 126, 152, 160, 168, 178, and interface with the back end application 122 via the network 124. In some embodiments, one or more of the front end applications 150, 158, 166, 176, 186 may be embodied as a mobile software application that is downloadable to a mobile device. In other embodiments, one or more of the front end BPN applications 150, 158, 166, 176, 186 may be hosted by the user networking service computing device 102 and accessible to the computing devices 126, 152, 160, 168, 178 via the network 124.

Referring further to FIG. 1, the user networking service computing device 102 may be embodied in or as any type of computing device or network of computing devices capable of performing at least the functions described herein as being performable by a computing device associated with a user networking service and/or a back end BPN application. For example, all or portions of the computing device 102 may be embodied in or as a desktop computer, a server, an enterprise computer system, a network of computers, an Internet-enabled hosting service, or other electronic device, system, or combination of any of the foregoing, which is capable of facilitating bulk purchase negotiations by ad hoc online groups and electronic commerce transactions resulting from the bulk purchase negotiations, as described herein.

The illustrative user networking service computing device 102 includes at least one processor 104, a memory 106, an input/output (I/O) subsystem 108, a storage device 110, communication circuitry 112, and one or more peripheral devices 114. One or more of the foregoing components may be incorporated on a motherboard of the user networking service computing device 102 while other components may be communicatively coupled to the motherboard via, for example, a peripheral port.

The user networking application 120 and the BPN back end application 122 are installed on the computing device 102. In the illustrative embodiment, the user networking application 120 and the BPN application 122 reside in the storage device 110. In other embodiments, all or other portions of the user networking application 120 and the BPN back end application 122 may reside in other locations accessible to the processor 104. For example, portions of the user networking application 120 and/or the BPN back end application 122 may be loaded into the memory 106 during operation of the computing device 102, for faster processing or other reasons. In some embodiments, portions of the user networking application 120 and/or the BPN back end application 122 may reside on one or more other physical or logical (e.g., virtual) storage devices accessible by the processor 104.

The illustrative processor 104 may be embodied as one or more processor cores or logical sections of a single core 116. In addition to cache memory, the processor 104 and/or its core(s) include, or are otherwise communicatively coupled to, the memory 106. Portions of the memory 106 may be embodied as any type of suitable memory device, such as a dynamic random access memory device (DRAM), synchronous dynamic random access memory device (SDRAM), double-data rate dynamic random access memory device (DDR SDRAM) and/or other volatile memory devices. Although a single memory device 106 is illustrated in FIG. 1, in other embodiments, the computing device 102 may include additional (e.g., logical or physical) memory devices. Various data and/or computer instructions, such as operating systems, applications, programs, libraries and drivers executable by the processor 104, may reside in the memory 106 during operation of the system 100.

The processor 104 is also communicatively coupled to the I/O subsystem 108. Although not specifically shown, the I/O subsystem 108 typically includes a memory controller (e.g., a memory controller hub (MCH) or northbridge), an input/output controller (e.g., an input/output controller hub (ICH) or southbridge), and a firmware device (e.g., BIOS or UEFI). Of course, in other embodiments, I/O subsystems having other configurations may be used. For example, in some embodiments, the I/O subsystem 108 may form a portion of a system-on-a-chip (SoC) and be incorporated, along with the processor 104 and other components of the computing device 102, on a single integrated circuit chip. As such, it will be appreciated that each component of the I/O subsystem 108 may be located on a common integrated circuit chip in some embodiments.

The I/O subsystem 108 is communicatively coupled to the storage device 110. Portions of the storage device 110 may be embodied as any suitable device for storing data and/or computer instructions, such as disk storage (e.g. hard disks), a network of physical and/or logical storage devices, and/or others. In addition to the user networking application 120 and the BPN back end application 122, one or more operating systems, application programs and/or data structures may be embodied in the storage device 110, in some embodiments.

In some embodiments, the I/O subsystem 108 may include a security engine 118 configured to interface with the BPN back end application 122 to facilitate bulk purchase negotiations and, should a negotiation conclude in an agreement, an electronic commerce transaction between one more of the BPN group computing devices 126, 168, 178 and one or more of the vendor devices 152, 160. The security engine 118 generally includes computerized logic configured to perform security, encryption, decryption, and/or authentication functions. The security engine 118 may be embodied as hardware, software, firmware, and/or a combination thereof. For example, the security engine 118 may be embodied as or include a trusted platform module (TPM) and/or other security enhancing hardware and/or associated software or firmware modules. The security engine 118 can interface with one or more corresponding security engines 144, 156, 164, 174, 184 of the BPN group representative computing device 126, the vendor devices 152, 160, and the BPN group member computing devices 168, 178, respectively, to effect secure transmission of purchase and/or payment information over the network 124 and among the various devices 102, 126, 152, 160, 168, 178, as needed by the BPN application 122, 150, 158, 166, 176, 186, or otherwise, to facilitate bulk purchase negotiations and/or electronic commerce transactions, as the case may be.

The communication circuitry 112 of the computing device 102 may be embodied as one or more devices and/or circuitry configured to enable communications between the computing device 102, the BPN group representative computing device 126, the BPN group member computing devices 168, 178, and/or the vendor devices 152, 160, via the network 124. The communication circuitry 112 is communicatively coupled to the I/O subsystem 108, and may include one or more wired and/or wireless network interfaces to facilitate communications over the wired and/or wireless portions of the network 124.

The I/O subsystem 108 may be communicatively coupled to one or more peripheral and/or interface devices 114. The peripheral device(s) 114 may include one or more network interfaces, graphics and/or video adaptors, keyboards, keypads, touchscreens, displays, printers, data storage devices, a computer mouse, and/or other peripheral devices, depending upon, for example, the intended use of the computing device 102. Further, it should be appreciated that the computing device 102 may include other components, sub-components, and devices not illustrated in FIG. 1 for clarity of the description.

Referring still to FIG. 1, the illustrative BPN group representative computing device 126 may be embodied in or as any type of computing device capable of performing at least the functions described herein as being performable by a computing device associated with a designated representative of a BPN group and/or a BPN group member. For example, all or portions of the BPN group representative computing device 126 may be embodied in or as a mobile computing device, such as a cellular phone, a smart phone, a mobile Internet device, a handheld, laptop or tablet computer, a personal digital assistant, a telephony device, or other portable electronic device; or as a desktop computer, a server, an enterprise computer system, a network of computers, an Internet-enabled hosted service, or other electronic device, system, or combination of any of the foregoing; which can enable its user to engage in bulk purchase negotiations and/or electronic commerce transactions resulting from a bulk purchase negotiation, as a representative or member of an ad hoc online group, as described herein. For example, in some embodiments, a BPN group representative may conduct bulk purchase negotiations with one or more vendors on behalf or a BPN group. The BPN group representative may be, for example, a member of the BPN group; or may be a third party designated by the BPN group, by the operator of the user networking service computing device 102, or by one or more of the vendors involved in the BPN. In other embodiments, one or more of the individual members of a BPN group may negotiate directly with the one or more vendors involved in the BPN, in which case, the associated BPN group member computing device(s) 168, 178 may include one or more of the features of the BPN group representative computing device 126.

The illustrative BPN group representative computing device 126 includes at least one processor 128, a memory 130, an input/output (I/O) subsystem 132, flash memory 134, a storage device 136, communication circuitry 138, and one or more peripheral devices 140. One or more of the foregoing components may be incorporated on a motherboard of the computing device 102 while other components may be communicatively coupled to the motherboard via, for example, a peripheral port.

In the illustrative embodiment, cryptographic information 146 and payment credentials 148 are stored in memory of the BPN group representative computing device 126, and the BPN group representative front end application 150 is installed on the BPN group representative computing device 126. In the illustrative embodiment, the payment credentials 148 and the BPN group representative front end application 150 reside in the storage device 136, while the cryptographic information 146 is stored in the flash memory 134 (which is non-volatile). In other embodiments, all or other portions of the payment credentials 148, cryptographic information 146, and/or the BPN group representative front end application 150 may reside in other locations accessible to the processor 128. For example, portions of the payment credentials 148 and/or the BPN group representative front end application 150 may be loaded into the memory 130 during operation of the computing device 126, for faster processing or other reasons. In some embodiments, portions of the payment credentials 148 and/or the BPN group representative front end application may reside on one or more other physical or logical (e.g., virtual) storage devices accessible by the processor 128.

The illustrative processor 128 of the BPN group representative computing device 126 may be embodied as one or more processor cores or logical sections of a single core 142. In addition to cache memory, the processor 128 and/or its core(s) include, or are otherwise communicatively coupled to, the memory 130. Portions of the memory 130 may be embodied as any type of suitable memory device, such as a dynamic random access memory device (DRAM), synchronous dynamic random access memory device (SDRAM), double-data rate dynamic random access memory device (DDR SDRAM) and/or other volatile memory devices. Although a single memory device 130 is illustrated in FIG. 1, in other embodiments, the computing device 126 may include additional (e.g., logical or physical) memory devices. Various data and/or computer instructions, such as operating systems, applications, programs, libraries and drivers executable by the processor 128, may reside in the memory 130 during operation of the system 100.

The processor 128 of the BPN group representative computing device 126 is also communicatively coupled to the I/O subsystem 132. Although not specifically shown, the I/O subsystem 132 typically includes a memory controller (e.g., a memory controller hub (MCH) or northbridge), an input/output controller (e.g., an input/output controller hub (ICH) or southbridge), and a firmware device (e.g., BIOS or UEFI). Of course, in other embodiments, I/O subsystems having other configurations may be used. For example, in some embodiments, the I/O subsystem 132 may form a portion of a system-on-a-chip (SoC) and be incorporated, along with the processor 128 and other components of the computing device 126, on a single integrated circuit chip. As such, it will be appreciated that each component of the I/O subsystem 108 may be located on a common integrated circuit chip in some embodiments.

The I/O subsystem 132 of the BPN group representative computing device 126 is communicatively coupled to the storage device 136. Portions of the storage device 136 may be embodied as any suitable device for storing data and/or computer instructions, such as disk storage (e.g. hard disks), a network of physical and/or logical storage devices, and/or others. In addition to the payment credentials 148 and the BPN application 150, one or more operating systems, application programs and/or data structures may be embodied in the storage device 136, in some embodiments.

In some embodiments, the I/O subsystem 132 of the BPN group representative computing device 126 may include a security engine 144, which may be configured to interface with the BPN group representative front end application 150 to engage in bulk purchase negotiations and, should a negotiation conclude in an agreement, an electronic commerce transaction involving the BPN group representative computing device 126 and one or more of the vendor devices 152, 160. The security engine 144 generally includes computerized logic configured to perform security, encryption, decryption, and/or authentication functions. The security engine 144 may be embodied as hardware, software, firmware, and/or a combination thereof.

For example, the security engine 144 may be embodied as or include a trusted platform module (TPM) and/or other security enhancing hardware and/or associated software or firmware modules. In general, the security engine 144 is configured to interface with one or more corresponding security engines 118, 156, 164, 174, 184 of the user networking service computing device 102, the vendor devices 152, 160, and the BPN group member computing devices 168, 178, respectively, to effect secure transmission of purchase and/or payment information over the network 124 and among the various devices 102, 126, 152, 160, 168, 178, as needed by the BPN application 122, 150, 158, 166, 176, 186 or otherwise, to effectuate bulk purchase negotiations and/or electronic commerce transactions, as the case may be. Accordingly, in a similar or analogous fashion, each or any of the security engines 156, 164, 174, 184 generally includes computerized logic configured to perform security, encryption, decryption, and/or authentication functions, and may be embodied as hardware, software, firmware, and/or a combination thereof.

The security engine 144 may use cryptographic information 146 to encrypt digital messages that include the BPN group representative's personal payment information, such as payment credentials 148. The cryptographic information 146 may include a private key or other security mechanism unique to the user of the computing device 126 and usable by the security engine 144 as described above. Similarly, each or any of the security engines 118, 156, 164, 174, 184 may use cryptographic information 146, 172, 182 to encrypt, decrypt, or authenticate digital messages that include a BPN group representative or member's personal payment information. Accordingly, the cryptographic information 472, 182 may be similar or analogous to the cryptographic information 146 and may be embodied in memory (e.g., non-volatile memory) of each or any of the BPN group member computing devices 168, 178.

The payment credentials 148 may include, for example, one or more bank and/or credit card account numbers, authorization codes, and/or other similar or related information usable to effect payment in an electronic commerce transaction. In some embodiments, the payment credentials 148 may be stored as a digital wallet and/or managed by a digital wallet application. While not specifically shown, it should be understood that each or any of the BPN group member computing devices 168, 178 may include user-specific payment credentials similar or analogous to the payment credentials 148.

The communication circuitry 138 of the BPN group representative computing device 126 may be embodied as one or more devices and/or circuitry configured to enable communications between the BPN group representative computing device 126, the user networking service computing device 102, the BPN group member computing devices 168, 178, and/or the vendor devices 152, 160, via the network 124. The communication circuitry 138 is communicatively coupled to the I/O subsystem 132, and may include one or more wired and/or wireless network interfaces to facilitate communications over the wired and/or wireless portions of the network 124.

The I/O subsystem 132 of the BPN group representative computing device 126 may be communicatively coupled to one or more peripheral and/or interface devices 140. The peripheral device(s) 140 may include one or more network interfaces, graphics and/or video adaptors, keyboards, keypads, touchscreens, displays, printers, data storage devices, a computer mouse, and/or other peripheral devices, depending upon, for example, the intended use of the BPN group representative computing device 126. Further, it should be appreciated that the BPN group representative computing device 126 may include other components, sub-components, and devices not illustrated in FIG. 1 for clarity of the description.

The one or more BPN group member computing devices 168, 178, and the one or more vendor devices 152, 160 are, in the illustrative embodiment, computing devices. While details of the specific structure of the one or more BPN group member computing devices 168, 178, and the one or more vendor devices 152, 160 have been omitted so as not to obscure the disclosure, it should be understood that each of these devices generally includes one or more processors, memory, an I/O subsystem, storage device, and peripheral device(s) similar or analogous to those shown and described above in connection with the computing devices 102, 126.

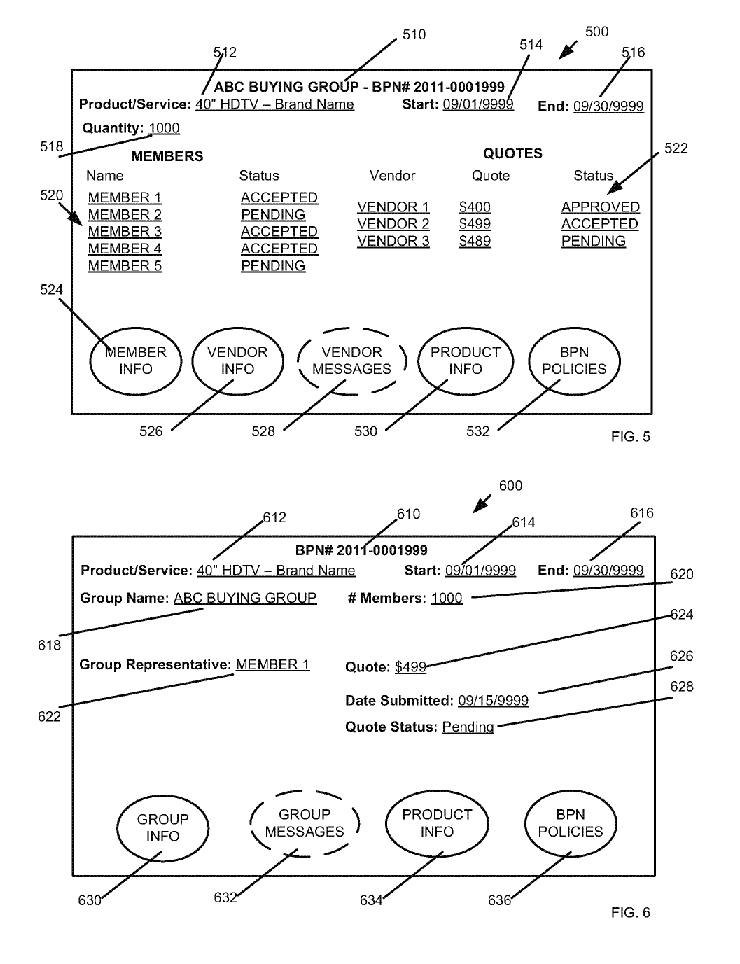

Further, with respect to the illustrative BPN group member computing devices 168, 178, the communication circuitry 170, 180, cryptographic information 172, 182, security engines 174, 184, and BPN front end applications 175, 186 are generally similar or analogous to the communication circuitry 138, cryptographic information 146, security engine 144, and BPN front end application 150 shown and described above in connection with the BPN group representative computing device 126, except that the BPN front end application 150 may be configured differently than the BPN front end applications 176, 186, as described below with reference to FIG. 5. In some embodiments, each or any of the BPN group member computing devices 168, 178 may be embodied as a mobile computing device such as a cellular phone, a smart phone, a mobile Internet device, a handheld, laptop or tablet computer, a personal digital assistant, a telephony device, or other portable electronic device; or as a desktop computer or other electronic device. As mentioned above, in some embodiments, the user designated as the BPN group representative may be a member of the BPN group, in which case the user's BPN group member computing device 168, 178 may be configured as a BPN group representative computing device 126.

Regarding the vendor devices 152, 160, the communication circuitry 154, 162, the security engines 156, 164, and the BPN front end applications 158, 166 are generally similar or analogous to the communication circuitry 138, security engine 144, and BPN front end application 150 shown and described above in connection with the BPN group representative computing device 126, except that the BPN front end applications 158, 166 may be configured differently than the BPN front end application 150, as described below with reference to FIG. 6. In some embodiments, portions of each or any of the vendor devices 152, 160 may be embodied as an electronic device (e.g., a desktop, handheld or portable computer or credit card scanner) operated by a vendor at a physical location (e.g., a checkout counter) of the vendor. In other embodiments, portions of the vendor devices 152, 160 may be embodied as software executable by or on behalf of the vendor, e.g., via the vendor's Internet web site or another online application.

The network 124 may be embodied as any type of wired and/or wireless telecommunications network. For example, the network 124 may be embodied as or otherwise include one or more public or private cellular networks, telephone, Digital Subscriber Line (DSL) or cable networks, local or wide area networks, publicly available global networks (e.g., the Internet), or any combination thereof. For example, in some embodiments, the network 124 may be embodied as or otherwise include a Global System for Mobile Communications (GSM) cellular network. Additionally, the network 124 may include any number of additional devices as needed to facilitate communication between or among the user networking service computing device 102, the BPN group representative computing device 126, the BPN group member computing 168, 178, and the vendor devices 152, 160, such as routers, switches, intervening computers and/or others. Any suitable communication protocol (e.g., TCP/IP) may be used to effect communication over the network 124, depending on, for example, the particular type or configuration of the network 124. In some embodiments, portions of the network 124 may be embodied not as a network in the traditional sense, but as a wireless, contactless communication medium configured to enable Near Field Communication or other short range wireless communications (e.g., NFC circuitry) between one or more of the BPN group computing devices 126, 168, 178 and one or more of the vendor devices 152, 160, for example.

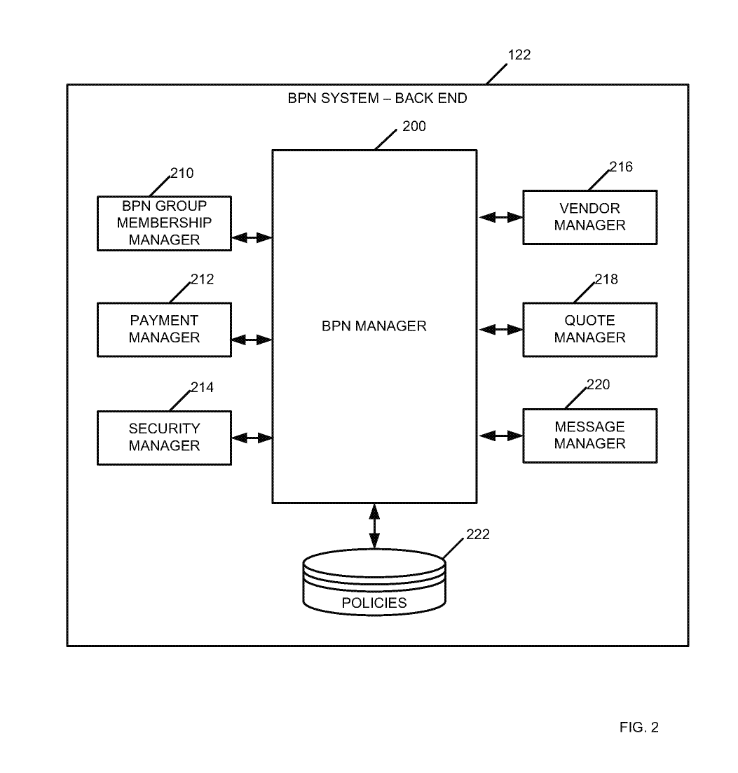

In general, the components of the user networking service computing device 102, the BPN group representative computing device 126, the BPS group member computing devices 168, 178, the vendor devices 152, 160, and the system 100 are communicatively coupled as shown in FIG. 1, by one or multiple signal paths (e.g., a bus), each of which may be represented schematically as single-line connections or, in the case of FIG. 2, double-headed arrows. Such signal paths may be embodied as any type of wired or wireless signal paths capable of facilitating communication between the respective devices. For example, the signal paths may be embodied as any number of wires, printed circuit board traces, via, bus, point-to-point interconnects, intervening device and/or the like.

Referring now to FIG. 2, computerized modules of the illustrative system 100, which may be embodied in or otherwise accessible to the user networking service computing device 102, are shown. A BPN manager module 200 is communicatively coupled to a BPN group membership manager module 210, a payment manager module 212, a security manager module 214, a vendor manager module 216, a quote manager module 218, a message manager 220, and a policies database 222.

The illustrative BPN manager module 200 is embodied as computerized logic that is configured to interface with time modules 210, 212, 214, 216, 218, 220 and the policies database 222, and receive and process messages, instructions and information transmitted from and among the devices 102, 126, 152, 160, 168, 178, during the formation of an ad hoc online BPN group and during the course of the BPN group's online bulk purchase negotiations and electronic commerce transactions (if any). For example, the BPN manager module 200 may receive a request (e.g., an instant message) from one of the devices 126, 168, 178 to form an ad hoc group for a BPN; initiate execution of the security manager 214 to verify that the request originated from a trusted source (e.g. using the security engine 118) and validate the requesting user's identifying information (e.g., a unique user identifier); and initiate execution of the BPN group membership manager module 210 to install the BPN front end applications 150, 158, 166, 176, 186 on one or more of the devices 126, 152, 160, 168, 178 and establish the BPN group in accordance with one or more policies maintained in the policies database 222.

As another example, the BPN manager module 200 may receive a request from a vendor device 152, 160 to participate in the BPN group's bulk purchase negotiation; initiate execution of the security manager 214 to verify that the request originated from a trusted source and validate the vendor's identifying information (e.g., a unique user identifier); initiate execution of the vendor manager module 216 to install the BPN front end application 158, 166 on one or more vendor devices 152, 160; initiate execution of the message manager 220 to establish a real-time electronic messaging interface between one or more of the vendor devices 152, 160 and one or more of the BPN group devices 126, 168, 178 in accordance with one or more of the policies maintained in the policies database 222; and initiate execution of the quote manager 218 to review and validate quotes submitted by approved vendors in accordance with one or more policies maintained in the policies database 222.

As yet another example, the BPN manager module 200 may receive information (e.g., a unique user identifier) from one of the devices 126, 152, 160, 168, 178 indicating that a particular user of one of the devices 126, 152, 160, 168, 178 is to be designated as the BPN group's representative in bulk purchase negotiations, initiate execution of the security manager 214 to verily that the information originated from a trusted source and validate the BPN group representative's identifying information, configure the designated BPN group representative's computing device as a BPN group representative computing device 126 (e.g., install the BPN front end application 150), and initiate execution of the message manager 220 to establish a real-time electronic messaging interface between the BPN group representative computing device 126 and one or more vendor devices 152, 160.

As a further example, the BPN manager module 200 may receive a message (e.g., an instant message) from the BPN group representative computing device 126 or one of the BPN group member computing devices 168, 178 or a vendor device 152, 160 indicating that a bulk purchase negotiation has successfully concluded with one of the vendors having submitted a successful quote, initiate execution of the security manager 214 to verify that the received information originated from a trusted source, and initiate execution of the payment manager 212 to initiate an electronic commerce transaction for the bulk purchase according to the agreed-upon terms as negotiated between the ad hoc online group and the vendor with the successful quote.

In general, execution of the BPN manager 200 and/or any of the modules 210, 212, 214, 216, 218, 220 at the user networking service computing device 102 may be triggered by an action occurring at one or more of the BPN front end applications 150, 158, 166, 176, 186. Each or any of the BPN front end applications 150, 158, 166, 175, 186 may be embodied as, for example, a plug-in for a web browser or a mobile application (“app”) launchable from a display or touchscreen of the respective device 126, 152, 160, 168, 178.

Referring still to FIG. 2, the illustrative BPN group membership manager 210 is embodied as computerized logic configured to activate and deactivate BPN groups and process BPN group membership requests in accordance with one or more policies maintained in the policies database 222. For example, a particular BPN group may require members to pay a certain amount to demonstrate their commitment to the group. Members who do not pay the commitment amount may not be eligible to participate in the bulk purchase negotiation or purchase the desired product, commodity or service at the bulk price or volume discount. As another example, a particular BPN group may specify a procedure (e.g., majority vote) for removing non-performing or inactive members from the group (e.g., late payers, non-payers, etc.). As a further example, a particular BPN group may specify that all members must pay the negotiated price to the designated BPN group representative before any member may receive the product, commodity or service. As yet another example, sonic BPN groups may determine that the designated BPN group representative is entitled to receive compensation and specify the terms thereof. As an additional example, some BPN groups may specify criteria for qualifying as a member. For example, in some embodiments, unknown or anonymous users may not be permitted to join certain BPN groups, or prospective group members may be required to submit one or more references before they are admitted to the group. As yet another example, some BPN groups may specify policies for dissolution, which may address whether and/or how to dissolve the group under a variety of circumstances. As still another example, some BPN groups may specify policies for maintaining the group (e.g., for limited purposes) after the BPN has concluded. The BPN group membership manager is configured to, among other things, review, admit, reject, and/or remove members of the BPN group, and form, maintain, dissolve and/or deactivate the BPN group, in these and other examples.

The illustrative payment manager 212 is embodied as computerized logic configured to interface with the security engines 118, 144, 156, 164, 174, 184, cryptographic information 146, 172, 182, and/or payment credentials 148 as needed to effect payments by one or more of the users of the BPN group computing devices 126, 168, 178. For example, in some embodiments, BPN group members may be required to make a payment to the BPN group representative in order to participate in a bulk purchase negotiation or to purchase the desired product, commodity or service at the negotiated price. As another example, upon successful conclusion of a bulk purchase negotiation, BPN group members may pay the negotiated price to the BPN group representative or directly to the successful vendor. Also, in some embodiments, BPN group members may pay compensation to the BPN group representative. The payment manager 212 is configured to, among other things, initiate electronic commerce transactions to make payment in these and other examples.

As discussed above, the illustrative security manager 214 is embodied as computerized logic configured to interface with one or more of the security engines 118, 144, 156, 164, 174, 184, cryptographic information 146, 172, 182, payment credentials 148 and/or other information and/or processes, as needed to verify, authenticate, and/or validate information and/or instructions communicated by, between, or among one or more of the devices 102, 126, 152, 160, 168, 178 during operation of the system 100.

The illustrative vendor manager 216 is embodied as computerized logic configured to accept, reject, activate and deactivate vendors participating in a BPN, and process vendor requests in accordance with one or more policies maintained in the policies database 222. For example, some BPN groups may require or request certain types of discounts in a bulk purchase negotiation (such as loyal customer or prompt payment discounts), and may not accept vendors who are not willing to offer those discounts. As another example, some BPN groups may specify a physical or virtual location or address (e.g., post office address or electronic mail address), date and/or time for delivery of the desired product, commodity, or service, and may not accept vendors who are unable to deliver to the specified address or at the specified date and/or time. As a further example, some BPN groups may require vendors to allow the purchased product, commodity or service to be returned or exchanged within a specified time period after deliver, and may reject vendors who are not willing to comply with the return or exchange requirements of the BPN group. The vendor manager 216 is configured to, among other things, manage vendor accounts in these and other examples.

The quote manager 218 is embodied as computerized logic configured to review and accept or reject quotes (e.g., tones of sale including price, quantity, payment terms, and the like) submitted by vendors participating in a BPN, in accordance with one or more policies maintained in the policies database 222. For example, some BPN groups may specify that quotes be submitted in a certain format, contain certain information, or be submitted within a certain time period. In some embodiments, if a quote does not satisfy the BPN group's requirements, it may be rejected or returned to the vendor for additional information, before it is considered by the BPN group. The quote manager 218 is configured to, among other things, manage the vendor quotes in these and other examples.

The message manager 220 is embodied as computerized logic configured to facilitate real-time electronic messaging (e.g., instant messaging) between and/or among the various participants in a BPN in accordance with one or more of the policies maintained in the policies database 222. For example, in the illustrative embodiment, the message manager 220 provides a real-time messaging interface between the BPN group representative computing device 126 and one or more of the vendor devices 152, 160 for the purpose of conducting bulk purchase negotiations, in such a way that the BPN group member computing devices 168, 178 cannot access the messages exchanged by the BPN group representative computing device 126 and the one or more vendor devices 152, 160. Also, in the illustrative embodiment, the message manager provides a real-time messaging interface between the BPN group representative computing device 126 and the BPN group member computing devices 168, 178, for communications exchanged by, between or among the BPN group members in such a way that the vendor devices 152, 160 cannot access the messages exchanged by the BPN group representative computing device 126 and the one or more BPN group member computing devices 168, 178. The message manager 220 is configured to, among other things, manage real-time electronic communications in these and other examples.

The policies database 222 may be embodied as one or more databases and/or other physical or logical data structures, and may reside on one or more physical or logical storage devices of or associated with at least the user networking service computing device 102. In general, the data collected and maintained in the policies database 222 can include preferences and/or rules of or associated with one or more BPN groups, BPN group members; products, commodities or services; bulk purchase negotiations, vendors, and/or quotes. The policies database 222 may be configured or updated periodically or on a routine basis, prior to, during or after operation of the system 100.

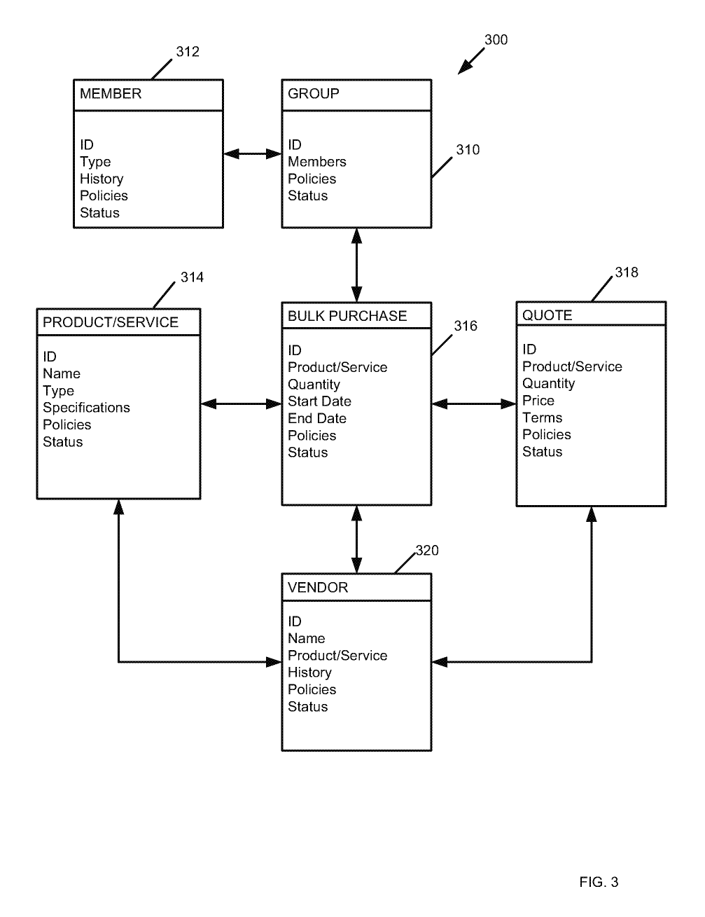

Referring now to FIG. 3, an illustrative data model 300 that may be used in connection with the policies database 222 is shown, including BPN group data 310, BPN group member data 312; product, commodity, and/or service data 314; bulk purchase negotiation data 316, quote data 318, and vendor data 320. In general, the double-headed arrows connecting the various data types as shown in FIG. 3 indicate many-to-many relationships or associations among the data types, although one-to-one and/or one-to-many relationships are also possible in some embodiments. For example, a group member 312 may be a member of many different BPN groups 310, and a BPN group 310 may have many different members 312. Similarly, a product, commodity, and/or service 314 may be offered by many different vendors 320, and each vendor 320 may offer many different products, commodities, and/or services 314. Likewise, a vendor 320 may be associated with multiple different quotes 318 (e.g., to different BPN groups), and a quote 318 may be associated with multiple vendors (e.g., if vendors bundle their products together for a special deal). Similarly, a BPN group 310 may be engaged in multiple bulk purchase negotiations 316, and each bulk purchase negotiation may have multiple BPN groups participating (e.g., if two or more BPN groups join forces to try to obtain a better deal). Also, a bulk purchase negotiation 316 may involve multiple products, commodities, and/or services (as in the case or bundling) and/or multiple quotes (e.g., from multiple vendors),

To implement policies, each data type 310, 312, 314, 316, 318, 320 includes at least one field or data store for storing policy information (e.g., rules and/or preference information). The policy data fields enable the BPN group representative, the BPN group members, and/or vendors to configure payment and/or other terms of a particular bulk purchase negotiation, BPN group membership terms, vendor qualification rules, and/or quote acceptance specifications, for example. As one example, a bulk purchase negotiation 318 may have an expiration date, after which the bulk purchase negotiation is no longer active, and a rule associated therewith that specifies that the BPN group is to be maintained with limited functionality (e.g., the ability of BPN members to view and post messages) after the expiration date passes. As noted above, in some embodiments, the policies database 222 can be used to track policies set by third parties such as vendors. For example, rules may be configured to specify payment policies, return policies, shipment policies, and/or others, associated with third parties such as product, commodity and/or services delivery services (e.g., FedEx) or method of payment vendors (e.g., PayPal, credit cards, and/or others).

Also, the illustrative data types 310, 312, 314, 316, 318, 320 have a status field or data store, which may be used to indicate the current status or a particular group, group member, product, commodity, and/or service; bulk purchase negotiation, quote, and/or vendor, as the case may be. For example, a BPN group 310 may have a status of “active” or “inactive.” A group member 312 or vendor 320 may have a status of “accepted,” “pending” “rejected,” or “removed.” A product, commodity, and/or service 314 may have a status of “in stock,” “on backorder,” etc. A quote 318 may have a status of “pending,” “accepted,” “rejected,” “expired,” or “approved.” A bulk purchase negotiation 316 may have a status of “pending,” “expired,” “complete-successful,” “complete-unsuccessful,” “canceled,” and/or others. It should be understood that each of the foregoing status identifiers is merely exemplary and that other, or additional, status identifiers may be used depending on the details and requirements of a particular implementation of the system 100. Moreover, the data model 300 and each of the illustrated elements is merely exemplary and it should be understood that other, or additional, data models and/or elements may be used depending on the details and/or requirements of a particular implementation of the system 100.

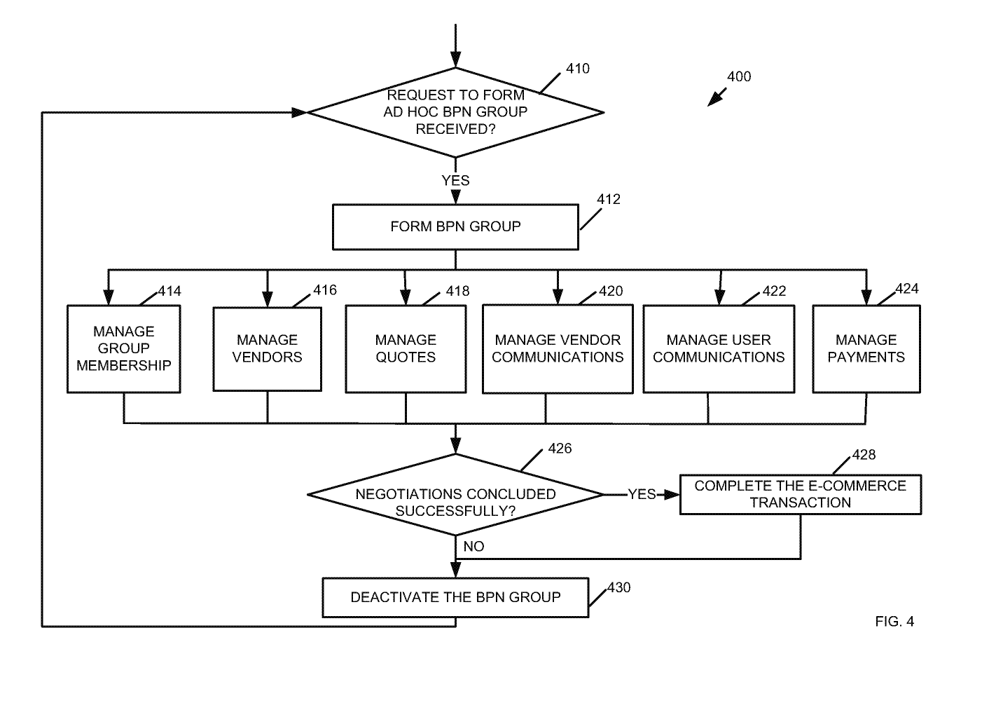

Referring now to FIG. 4, an illustrative method 400 executable by the system 100 is shown. At block 410, the BPN manager 200 periodically or continuously (e.g., as a background process) checks for a request from a user of a computing device 126, 152, 160, 168, 178 to form an ad hoc online BPN group for the purchase of a desired product, commodity and/or service. If such a request has been received, the method 400 proceeds to block 312. If a request has not been received, the method 400 continues to (e.g., periodicially or continuously) check for a request at block 310. At block 312, the BPN group is formed with the involvement of the BPN group membership manager 210, as described above. Formation of the BPN group involves, for example, establishing one or more of the policies maintained in the database 222 as discussed above. In some embodiments, the user initiating the formation of the BPN group may be a member of or subscriber to the user networking application 120. In some embodiments, the user initiating the BPN group formation may also be the BPN group representative; while in other embodiments, the BPN group representative may be another BPN group member or a vendor or a third party negotiator, for example; and in still other embodiments, no BPN group representative may be designated.

Once the BPN group is formed, tasks or instructions represented by one or more of the blocks 414, 416, 418, 420, 422, 424 may be executed (e.g., sequentially or in parallel), as needed to facilitate the bulk purchase negotiation. At block 414, the BPN group membership module 210 accepts or rejects requests for membership in the BPN group and otherwise manages membership in the BPN group as described above. At block 416, the vendor manager module 216 accepts or rejects requests from vendors to participate in a bulk purchase negotiation with the BPN group and otherwise manages vendor accounts and information as described above. At block 418, the quote manager module 218 accepts or rejects quotes submitted by vendors participating in a bulk purchase negotiation with the BPN group and otherwise manages quotes and related information as described above. At block 420, the message manager 220 manages the real-time electronic communications between the BPN group (or the BPN group representative, if one has been designated) and the vendor or vendors participating in the bulk purchase negotiation, as described above. Similarly, at block 422, the message manager 220 manages the real-time electronic communications between and/or among the BPN group members and/or between and/or among the BPN group representative and the BPN group members as described above. At block 424, the payment manager 212 manages electronic commerce transactions involving payments initiated or made in connection with membership in a BPN group or in connection with a bulk purchase resulting from a bulk purchase negotiation, as described above.

At block 426, the BPN manager 200 determines whether the bulk purchase negotiations have been concluded successfully. In some embodiments, the BPN manager 200 receives a communication from the BPN group representative computing device 126 indicating that agreement has been reached with a vendor on terms of a bulk purchase of a product, commodity, and/or service. In other embodiments, the BPN manager 200 may periodically check to see whether the status field associated with a quote 318 associated with the bulk purchase negotiation has changed to “APPROVED,” or other similar indicator to indicate that the negotiation has completed successfully.

If the bulk purchase negotiation has concluded successfully, then at block 28 the BPN manager 200 interfaces with the payment manager 212 as described above to initiate one or more electronic commerce transactions to make the bulk purchase by the BPN group. For example, in some embodiments, payments are collected by the BPN group representative from all of the BPN group members, and then the BPN group representative executes an electronic commerce transaction for the bulk purchase. In other embodiments, each BPN group member may pay the vendor associated with the approved quote, directly, using an electronic commerce transaction. At block 430, when the negotiations have concluded (whether or not successful), the BPN group is deactivated, at least in the sense that the real-time messaging between the BPN group or its representative and at least the unsuccessful vendor or vendors is terminated. However, certain aspects of the BPN group may remain available to one or more of the BPN group members, in some embodiments. For example, real-time messaging may be maintained with the successful vendor and/or the BPN group members for the purpose of coordinating or facilitating shipments or returns, or for other reasons.

Referring now to FIG. 5 an illustrative user interface 500 for a BPN group member representative front end application 150 or a BPN group member front end application 176, 186 is shown. The user interface 500 includes a name and/or unique identifier 510 for the BPN group and the current bulk purchase negotiation, a product, commodity and/or service identifier or description 512, the start date 514 of the bulk purchase negotiation, the end date 516 of the bulk purchase negotiation, and the quantity 518 of the product, commodity and/or service 512 desired to be purchased by the BPN group 510.

The user interface 500 also includes a list 520 of the members of the BPN group 510 and their current status, and a list 522 of the current quotes by vendors, and the status of each quote. In the illustrated embodiment, the status identifier “PENDING” is used to indicate a quote that has been received but not yet reviewed by the quote manager 218 to see if it conforms with the BPN group's policies; the status identifier “ACCEPTED” is used to indicate a quote that has been reviewed and accepted by the quote manager 218 for consideration by the BPN group; and the status identifier “APPROVED” is used to indicate a quote that has been approved by the BPN group and which will therefore result in an electronic purchase transaction. Underlining is used in FIG. 5 to indicate that in at least some embodiments, the underlined text may be implemented as a hyperlink, such that clicking on or otherwise selecting the underlined text results in the display of more detailed information about the selected item. For example, clicking on a member or vendor information may result in the display of additional details about the member or vendor, such as name, address, and the like.

The elements 524, 526, 528, 530, and 532 are selectable controls (e.g., touchscreen buttons) that also result in the display of additional information. The member info button 524 if selected may display additional or more detailed information about one or more of the BPN group members. Similarly, the vendor info button 526 if selected may display additional or more detailed information about one or more of the vendors participating in the bulk purchase negotiation, and the product info button 530 if selected may display additional or more detailed information about the product, commodity and/or services 512 or similar or related products, commodities, and/or services. The BPN policies button 532 if selected may display information relating to the policies of the BPN group relating to the bulk purchase negotiation. The vendor messages button 528 if selected launches the real-time messaging interface between the BPN group and/or its representative and the vendor(s) participating in the bulk purchase negotiation. The button 528 is shown in phantom because in some embodiments, it may not be displayed. For example, if a BPN group representative has been designated, the BPN front end applications 176, 186 for the other members of the BPN group will not display the button 528 or the BPN group-vendor messaging interface. Also, in some embodiments, members of the BPN group may limit the amount of information about themselves that other members of the BPN group can see. Thus, for example, an implementation of the user interface 500 at a particular BPN group member computing device 168, 178 may display a hyperlink only under the member name or ID 520 of the BPN group member associated with that device, and/or the member info button 524 ma only display the user's own personal and/or other information, and not information about the other BPN group members.

Referring now to FIG. 6, an illustrative user interface 600 for a BPN front end application 158, 166 (e.g., a vendor front end) is shown. The user interface 600 includes: a name and/or unique identifier 610 for the current bulk purchase negotiation, a product, commodity and/or service identifier or description 612, the start date 614 of the hulk purchase negotiation, the end date 616 of the bulk purchase negotiation, the name 618 of the BPN group; the name or an identifier (e.g., user ID) for the BPN group representative 622 (if any); the number of members 620 in the BPN group 618; the vendor's current quote 624, date submitted 626, and status 628. In the illustrative embodiment, some of the information displayed by the user interface 500 is also displayed by the user interface 600. Underlining is used in FIG. 6 to indicate that in at least some embodiments, the underlined text may be implemented as a hyperlink, such that clicking on or otherwise selecting the underlined text results in the display of more detailed information about the selected item. For example, clicking on the quote 624 may result in the display of additional details about the quote, such as payment terms, special discounts, expiration date of the quote, delivery or return policies, and/or others. The elements 630, 632, 634, 636, are selectable controls (e.g., touchscreen buttons) that also result in the display of additional information. The group info button 630 if selected may display additional or more detailed information the BPN group, but not, at least in some embodiments, information about individual group members. Similarly, the product info button 634 if selected may display additional or more detailed information about the product, commodity and/or services 512 or similar or related products, commodities, and/or services. The BPN policies button 636 if selected may display information relating to the policies of the BPN group relating to the bulk purchase negotiation 610. The group messages button 632 if selected launches the real-time messaging interface between the vendor and the BPN group and/or its representative. The button 632 is shown in dashed lines because in some embodiments, only authorized representatives of the vendor may access the messaging interface. In addition, in some embodiments, only vendors who have been accepted into the bulk purchase negotiation by the BPN group may access the messaging interface. As such, the button 632 may not be available in all implementations of the BPN front end application 158, 166. Also, in some embodiments, the messaging interface accessible via the group messages button 632 may allow vendors to see only their own electronic interactions with the BPN group; while in other embodiments, vendors may see the electronic interactions or selected portions thereof, between other vendors and the BPN group. With regard to FIGS. 5 and 6, it should be understood that each of the illustrated user interface elements is merely exemplary and that other, or additional, user interfaces and/or elements may be used depending on the details and/or requirements of a particular implementation of the system 100.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected. Further, while aspects of the present disclosure have been described in the context of a mobile commerce system, it will be understood that the various aspects have other applications, for example, in desktop or other non-portable computing devices, and in any electronic commerce application in which it may be desirable to analyze a user's finance-related information prior to, during, or after completion of a contemplated electronic commerce transaction.

1-67. (canceled)

68. At least one computer accessible medium comprising a plurality of instructions that in response to being executed cause a first computing device to:
receive, at a first computing device, from a user of a second computing device, a request to form an online group to conduct, via the first computing device, a negotiation with at least one vendor of a product or service using a third computing device, for a bulk purchase of the product or service;
facilitate, at the first computing device, electronic communications between the user and at least one member of the group using at least one fourth computing device, regarding the negotiation for the bulk purchase;
facilitate, at the first computing device, electronic communications between the group and the at least one vendor regarding the negotiation for the bulk purchase;
determine whether an agreement has been reached between the group and one of the vendors regarding the bulk purchase; and
initiate an electronic commerce transaction to complete the bulk purchase of the product or service by the group from the one vendor, in response to determining that an agreement has been reached between the group and the one vendor.

69. The at least one computer accessible medium of claim 68, wherein the plurality of instructions cause the first computing device to receive, at the first computing device, a designation of a user as a representative of the group and only permit electronic communications between the group representative and the at least one vendor regarding the negotiation for the bulk purchase.

70. The at least one computer accessible medium of claim 69, wherein the plurality of instructions cause the first computing device to restrict access to the electronic communications between the group representative and the at least one vendor to only the group representative and the at least one vendor.

71. The at least one computer accessible medium of claim 68, wherein the plurality of instructions cause the first computing device to secure the identities of the members of the group from access by the at least one vendor.

72. The at least one computer accessible medium of claim 68, wherein the plurality of instructions cause the first computing device to facilitate electronic communications among the user and the members of the group relating to at least one policy for membership in the group.

73. The at least one computer accessible medium of claim 72, wherein the plurality of instructions cause the first computing device to approve membership of a user in the group in accordance with at least one of the policies for membership in the group.

74. The at least one computer accessible medium of claim 72, wherein the plurality of instructions cause the first computing device to remove a member from the group in accordance with at least one of the policies for membership in the group.

75. The at least one computer accessible medium of claim 68, wherein the plurality of instructions cause the first computing device to facilitate electronic communications among the user and the members of the group relating to at least one policy for the bulk purchase of the product or service.

76. The at least one computer accessible medium of claim 68, wherein the plurality of instructions cause the first computing device to display, with the first, second, third or fourth computing devices, information relating to at least one term of the bulk purchase.

77. The at least one computer accessible medium of claim 68, wherein the plurality of instructions cause the first computing device to display, with the first, second, third or fourth computing devices, information relating to a quote submitted by one of the vendors.

78. The at least one computer accessible medium of claim 77, wherein the plurality of instructions cause the first computing device to restrict access to the quote information to only a designated representative of the group and the vendor.

79. The at least one computer accessible medium of claim 68, wherein the plurality of instructions cause the first computing device to accept a quote submitted by at least one of the vendors in accordance with at least one policy of the group.

80. The at least one computer accessible medium of claim 68, wherein the plurality of instructions cause the first computing device to display, with the first, second, third or fourth computing devices, information relating to at least one of the members of the group.

81. The at least one computer accessible medium of claim 80, wherein the plurality of instructions cause the first computing device to restrict access to the member information to only members of the group.

82. The at least one computer accessible medium of claim 68, wherein the plurality of instructions cause the first computing device to display, with the first, second, third or fourth computing devices, information relating to at least one of the vendors.

83. The at least one computer accessible medium of claim 68, wherein the plurality of instructions cause the first computing device to display, with the first, second, third or fourth computing devices, information relating to the product or service.

84. The at least one computer accessible medium of claim 68, wherein the plurality of instructions cause the first computing device to determine at least one term of the bulk purchase based on a characteristic of the group.

85. The at least one computer accessible medium of claim 68, wherein the plurality of instructions cause the first computing device to determine at least one term of the bulk purchase based on a characteristic of a member of the group.

86. A mobile electronic device comprising:
at least one processor; and
computer circuitry coupled to the at least one processor, the computer circuitry being arranged to cause the at least one processor to:
send, on behalf of a user of the mobile electronic device, to a second electronic device, a request to form a group to conduct an online negotiation with at least one vendor of a product or service for a bulk purchase of the product or service;
approve at least one second user as a member of the group in accordance with at least one membership policy of the group;
electronically communicate with the at least one member of the group regarding the negotiation for the bulk purchase;
electronically communicate with at least one vendor regarding at least one quote relating to the bulk purchase;
approve a quote for the bulk purchase from at least one of the vendors in accordance with at least one purchase policy of the group; and
initiate an electronic commerce transaction for the bulk purchase of the product or service by the group from the at least one vendor associated with the approved quote.

87. The mobile electronic device of claim 86, wherein the computer circuitry is arranged to cause the at least one processor to receive a designation of a user as a representative of the group and only permit electronic communications between the group representative and the at least one vendor regarding the negotiation for the bulk purchase.

88. The mobile electronic device of claim 87, wherein the computer circuitry is arranged to cause the at least one processor to restrict access to the electronic communications between the group representative and the at least one vendor to only the group representative and the at least one vendor.

89. At least one computer accessible medium comprising a plurality of instructions that in response to being executed cause a first computing device to:
receive, from a user of a second computing device, a request to form an online group to conduct a negotiation with at least one vendor of a product or service using a third computing device for a bulk purchase of the product or service;
form the online group in accordance with at least one policy for forming an online group for bulk purchases;
approve at least one second user using at least one fourth computing device as a member of the group, in accordance with at least one membership policy of the group;
facilitate electronic communications between the user and the at least one member of the group regarding the negotiation for the bulk purchase;
approve at least one quote for the bulk purchase from at least one of the vendors, in accordance with at least one purchase policy of the group;
facilitate electronic communications between a representative of the group and the at least one vendor regarding the quote;
determine whether an agreement has been reached between the representative of the group and one of the vendors regarding the bulk purchase;
initiate an electronic commerce transaction, in accordance with at least one policy of the group, for the bulk purchase of the product or service by the group from the one of the vendors, in response to determining that an agreement has been reached between the group and the one of the vendors;
selectively display, with the first, second, third, or fourth computing devices, information relating to the user, the group, the at least one second user, the representative of the group, the at least one vendor, the product or service, the negotiation, the bulk purchase, the agreement, the at least one policy for forming an online group for bulk purchases, the at least one membership policy, the at least one purchase policy, or the at least one policy of the group, and
deactivate the group in accordance with at least one of the policies of the group.

90. The at least one computer accessible medium of claim 89, wherein the plurality of instructions cause the first computing device to secure the identities of the members of the group from access by the at least one vendor.
